(19) United States
(12) Patent Application Publication
(10) Pub. No.: US 2006/0099112 A1
(43) Pub. Date: May 11, 2006

(54) Biospecimen handling apparatus and method

(75) Inventor: Todd Richardson Fitz, Mound, MN (US)

Correspondence Address: BLACKWELL IGBANUGO P.A., 3601 WEST 76TH STREET, SUITE 250, MINNEAPOLIS, MN, 55435, US

(73) Assignee: Fitzco, Incorporated, Spring Park, MN (US)

(21) Appl. No.: 11/266,801

(22) Filed: Nov. 4, 2005

Related U.S. Application Data
(60) Provisional application No. 60/625,732, filed on Nov. 5, 2004.

(51) Int. Cl. B01L 3/00

(52) U.S. Cl. 422/72; 422/102

(57) ABSTRACT

An apparatus for collecting, transporting and storing biospecimen. The apparatus includes a vial having a first open and second closed end. The apparatus includes an inner tube suitable for insertion into the vial and having a first open and second end. The apparatus also includes a lid to cover the first open end of the vial. The inner tube preferably includes a trapping means at the inlet of the first open end. A solution is preferably introduced into the vial. Biospecimen is typically introduced into the first open end of the inner tube, the lid closed and the apparatus agitated to cause the biospecimen to be eluted into the solution.

### RELATED APPLICATION

This application claims the benefit of a pending U.S. provisional application Ser. No. 60/625,732, filed Nov. 05, 2004, titled Biospecimen Handling Apparatus and Method, which is herein incorporated by reference.

### BACKGROUND

Biological specimen, such as, for example, saliva, blood, DNA composites, recombinant DNA, and nucleic acids from organisms, must often be collected in the field or “at the scene” remote from suitable testing, archival, and/or analytical facilities while preserving the integrity of the specimen. The efficient collection, transportation and storage of such biological specimen become paramount, particularly where the analyses and results are used to solve crimes or are to be used in the prosecution of criminal offenses such as sexual assault, murder, drunk driving, etc. Other applications where the preservation of the integrity of samples during the collection, transporting and storage process are paramount include plant and animal sciences and other agriculture related fields, and environmental and public health fields, to name but a few.

Several systems have been developed or adopted to collect biological specimen, including pouches, envelopes, bottles, and the like. Pouches and envelopes can be easily ripped, whereas bottles are often clumsy or difficult to use when collecting samples. There are still other systems that require manually handling the specimen before testing. While these systems may serve their intended purpose, they are generally unsuitable for the increasingly demanding environments for collecting and analyzing the collected biological specimen.

Accordingly, there is a need among forensic and law enforcement personnel, health care workers, parents, and others entrusted or charged with the responsibilities of obtaining, transporting and storing biological specimen for an apparatus and method that enables an efficient means to collect, transport, store, and retrieve the specimen in an effective, cost efficient system and wherein such a system can be used with automated processing systems. Such a method and apparatus are disclosed in the present invention.

### SUMMARY

In one embodiment, the present invention provides a method for handling a biospecimen. The method of the present invention includes the collection of a biospecimen and depositing the collected biospecimen in an apparatus that includes a vial comprising a first open and a second closed end. The first open end of the vial is preferably suitable to receive an inner tube. The inner tube of the present invention is suitable for insertion into the first open end of the vial, comprises a first open end and a second end that is formed with at least an aperture. The inner tube further includes a trapping means that is adaptable to retain the collected specimen in the second end portion of the inner tube. The apparatus of the present invention preferably includes a lid portion that is suitable for covering over the first open end of the vial with or without the inner tube inserted therein. When in use, an eluting solution is introduced into the vial, a biospecimen is then introduced into the inner tube through the trapping means and the lid placed on the first open end of the vial. The apparatus of the present invention is then preferably agitated to cause contact between the solution in the vial and the biospecimen in the inner tube, thus causing the biospecimen to be eluted into the solution of the vial.

The present invention also provides a system that is adaptable for use in manual and automated analytical systems. In automated systems, the present invention further provides a means to analyze the specimen without manual handling, thereby improving efficiency, enhancing safety and reducing the potential for contamination of the specimen. The apparatus may be used for short and long term storing biospecimen for later retrieval and analysis or for other purposes. The apparatus also may be adapted to include an identification tag or label that is usable to identify the collected specimen and/or recording other pertinent information with respect to the collected specimen.

### BRIEF DESCRIPTION OF THE DRAWINGS

FIG. 1 is a perspective view of an embodiment of the biospecimen handling apparatus of the present invention shown in the closed position.

FIG. 2 is a perspective view of the apparatus of FIG. 1 in an open position showing a side view of the lid.

FIG. 3 is a perspective view of the apparatus of FIG. 1 in an open position showing the inside view of the lid.

FIG. 4 is a perspective view of the inner tube of the present invention.

FIG. 5 is a lateral view of the inner tube of FIG. 4.

FIG. 6 is an enhanced view of the second end of the inner tube of FIG. 4.

### DETAILED DESCRIPTION

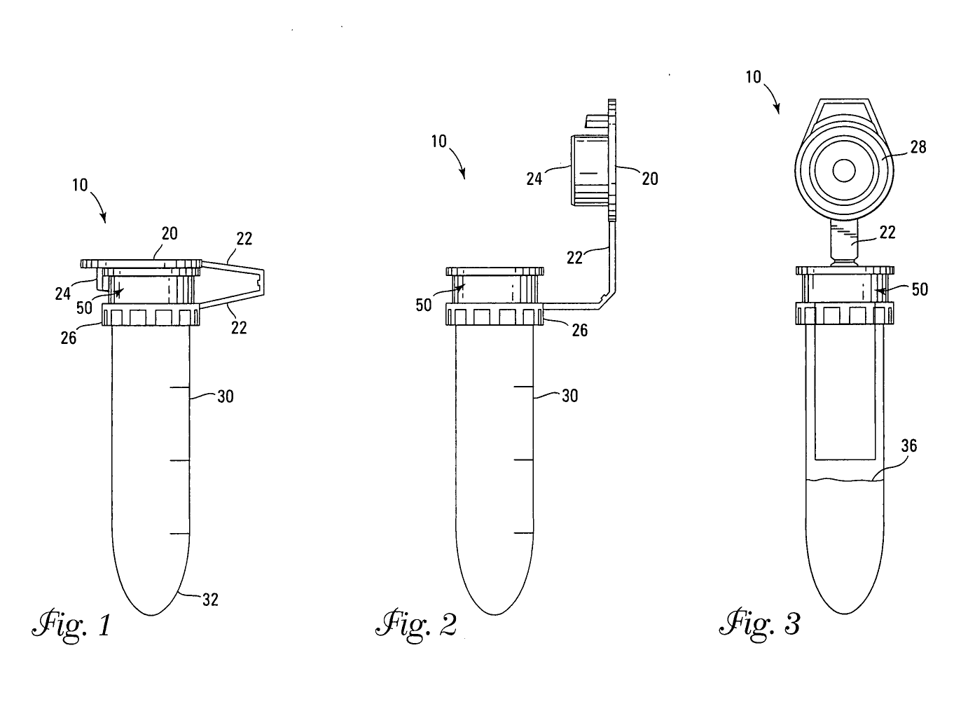

FIGS. 1-3 illustrate a preferred embodiment of the present invention in the form of an apparatus 10 for handling biological specimen, such as, for example, saliva, blood, plasmids, DNA composites, recombinant DNA, nucleic acids from organisms, or any other biological specimen for which the integrity of the specimen is desired to be maintained throughout the collection, transportation, storage, and testing or analysis processes. In this disclosure, biological specimen and biospecimen are used interchangeably.

The apparatus 10 is preferably adapted for use in both manual and automated systems used in the analysis of biological specimen. Typical automated systems include equipments manufactured and marketed by companies including, Perkin-Elmer®, Beckman®, Tecan®, Wallach®, Packard®, and Hamilton®.

The apparatus 10 preferably comprises a vial 30 having a first open end 26 and a second closed end 32. The first open end 26 is preferably suitable to receive an inner tube 50. The inner tube 50 preferably includes a first open end and a second end, and is preferably suitable for insertion into the first open end of the vial 30. The second end of the inner tube 50 is preferably formed with at least an aperture or apertures 60. The apparatus of the present invention preferably includes a lid portion 20 that is suitable for covering over the first open end of the tube 10 with or without the inner tube 50 inserted therein. The vial 30 is preferably suitable for receiving a solution 36. As discussed in greater detail later, the solution 36 is preferably introduced into the vial 30 to a level that may not contact the second end 60 of the inner tube 50.

The biospecimen is preferably introduced into the inner tube 50, prior to or after the inner tube 50 had been inserted into the tube and after the solution has been introduced into the vial 30. The lid is preferably then placed over the vial 30 and the apparatus 10 agitated. The agitation of the apparatus 10 preferably enables contact of the solution with the biospecimen on a swab or matrix elutes the biospecimen for further use or analysis.

Although FIGS. 1-3 show the vial 30 as being substantially tubular with a conical second end 32, it should be appreciated that the second end 32 of the vial 30 may be any desired shape, including flat, recessed or any other shape. Additionally, the vial 30 is not restricted in shape to circular shaped tubes, but any desired shape that allows for collection, preservation, storage, and transportation of the biospecimen. Additionally, the vial 30 may be formed from a single or multiple pieces of material, and may be made of any desired material capable of receiving and holding a desired biological specimen. If the vial 30 is comprised of a combination of multiple pieces, it is desirable to ensure the combination of pieces are securely connected together by any well known means to prevent premature dismantling during use, or other unintended results.

The first open end 26 of the vial 30 preferably includes a rim portion. The rim portion may be usable to secure the vial 30 in a storage or holding device to prevent the vial 30 from sliding downwardly through a holder or otherwise being unstable. The lid portion 20 may be removably or operably attached to the rim portion as shown in FIGS. 1-3.

As discussed above, the lid portion 20 may be operably connected to the vial 30. The lid portion 20 preferably includes an extension 24 such that when placed over the first open end 26 of the vial 30 with or without the inner tube 50 inserted therein, the lid portion 20 latches and covers tightly over the first open end 26 and sufficient to prevent undue loss of the biospecimen introduced therein. In some instances, the lid portion 20 may be formed to include a lip for easy removal. It is also conceivable that pertinent information including identification, collection date, type of material collected, and the like, may be stored in the lid portion of the apparatus 10. The storage of pertinent information may be accomplished by any method known in the art, including 10 embedding a chip, coding, and the like.

FIGS. 4-6 illustrate the inner tube 50 of the present invention. The inner tube 50 includes a trapping means 55 that is fixedly attached to the inlet of the open end of the inner tube 50. The inner tube also preferably includes an o-ring or casket 25 that is suitable to ensure a tight fit when the inner tube 50 is inserted in the first open end 26 of the vial 30. The means 55 is preferably adaptable to prevent an introduced biospecimen collection article from being untimely dislodged from the inner tube 50. As shown in FIG. 5, the means 55 is usable to retain the biospecimen during agitation to elute the biospecimen from the inner tube 50. Also, the inner tube 50 preferably includes at least an aperture 60 at the second end.

The desired dimensions of the inner tube 50 may be as desired by one skilled in the art but preferably such that it fits tightly into the vial 30, thus preventing the untimely release of solution during transportation or when otherwise agitated. As previously noted, the first open end of the inner tube 50 is preferably similar to that of the vial 30 such that when in use, the lid portion 20 may be usable to cover either the open end of vial 30 or inner tube 50.

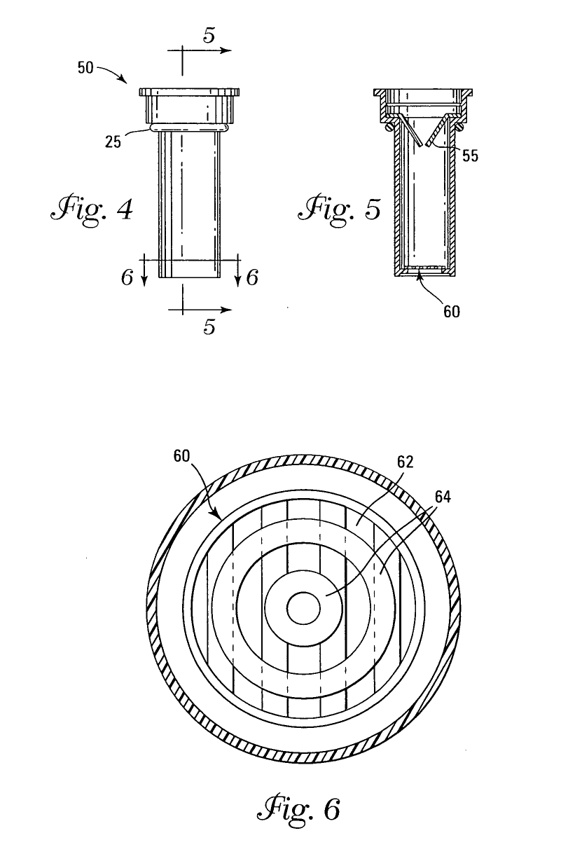

The aperture 60 of the inner tube 50 is preferably arranged such that when the apparatus is agitated, the solution in the vial 30 contacts the biospecimen in the inner tube 50 as discussed in detail below. The aperture 60 may be one or several as shown in FIG. 6. The second end of the inner tube 50 may be flat, conical, or any desired shape. The inner tube of the present invention may be formed from any material or a combination of materials, such as plastic, metal, and the like.

In use, an eluting solution 36 is preferably introduced into the vial 30 of the present invention to a level that may be below the second end 60 of the inner tube 50, when inserted. The inner tube 50 is then inserted into the vial 30 with or without a biospecimen already in the inner tube 50. The biospecimen may be introduced into the inner tube 50 by any means known in the art. By way of example, buccal cells may be collected from the oral cavity of an individual using a swab, spatula or any other means as is known in the art. This swab, spatula or other containing the buccal cell sample is then slotted into the first open end of the inner tube 50 through the trapping means 55. As may be typical, a swab or spatula may include a matrix for receiving the biospecimen. The process of inserting and removing the matrix end of the swab or spatula preferably releases the swab or matrix with the biospecimen into the inner tube 50.

The solution 36 is preferably of such quality as can be used to elute, retain, or preserve the biospecimen. It is also preferable that the solution 36 is functional for all aspects of extraction and preservation of the biospecimen. Typical solutions usable in the present invention should not inhibit or alter the character or quality of the collected biospecimen.

After the introduction of the biospecimen into the inner tube 50, the lid portion 20 is placed to cover the first open end of the vial 30 and an agitation action is preferably added by shaking the tube manually or by other preferred means. The agitation action contacts the solution 36 with the matrix or swab having the biospecimen, thus transferring the biospecimen into the solution in the second end of the vial 30. The vial 30 is preferably then stored with or without the inner tube 50 of the present invention.

An identification label or tag may be placed or incorporated into the lid portion 20 or placed on the body of the vial 30 to ensure proper identification of the biospecimen and/or to record other relevant or desired data concerning the specimen.

As identified above, the collection of the specimen is preferably accomplished without manually handling the specimen, thus preventing contamination or introduction of foreign elements. Similar or modified processes may be incorporated depending on the specimen to be obtained, such as skin scrapes, samples from crime scenes, alcohol-related or driving-while-impaired (DWI) evidence, research samples, and the like. The closed apparatus 10 containing the collected biological specimen may then be safely and conveniently transported to a suitable location, such as a laboratory, a testing facility, storage or archival facility, or the like.

The testing or analysis of the collected biological specimen may be accomplished by presenting the apparatus 10 to appropriate personnel, or to a robotic and/or automated biological specimen analysis system.

The present invention provides a convenient and efficient specimen storage or retention system. After collection of the needed biological specimen, the apparatus 10 may be stored on a rack, shelf, drawer, and the like. The apparatus 10 is preferably storable in a rack, and may provide for easy labeling of the identity of each specimen (bar codes, numbers, names, etc.) for efficient retrieval.

Accordingly, the present invention provides a system that is easy to use in the collection, retention and transportation of biospecimen. With the present system, there is no particular need to store the swab or other collection instrument. However, if desired, the collection instrument may be retained along with the collected specimen within the inner tube 50 of the apparatus 10.

Another benefit of the present invention is the provision of an apparatus that is easy to handle, allows for the easy and quick retrieval of the substrate, and can be stored. The apparatus 10 of the present invention is easily transportable and may be tracked as needed when in transit. This is especially important to law enforcement and judicial system in tracking and determining “chain of custody” issues, among others. Bar codes or other suitable tracking aid may be placed on the edges of the apparatus for computer or other electronic equipment identification. This may provide a time-and-date stamp upon collection, as automatic and real-time recording of sampling is now practical.

Having thus described the preferred embodiments of the present invention, those of skill in the art will readily appreciate that the teachings found herein may be applied to yet other embodiments.

We claim:

1. An apparatus for handling a biospecimen, the apparatus comprising:
a vial having a first open and a second closed end;
an inner tube having a first open end and a second end formed with at least an aperture, the inner tube suitable for insertion into the first open end of the vial; and
a lid portion suitable for securely covering over the first open end of the vial with or without the inner tube inserted therein.

2. The apparatus of claim 1, wherein the vial is adaptable to receive a solution and the inner tube.

3. The apparatus of claim 1, wherein the inner tube includes a trapping means for retaining a collected biospecimen.

4. The apparatus of claim 3, wherein the trapping means is fixedly attached to the inlet of the open end of the inner tube.

5. The apparatus of claim 1, wherein the second end of the inner tube is formed with multiple apertures.

6. The apparatus of claim 1, wherein an identification label or tag is incorporated into the vial.

7. The apparatus of claim 1, wherein the vial includes a rim portion.

8. The apparatus of claim 1, wherein the lid portion is operably connected to the vial.

9. The apparatus of claim 1, wherein the lid portion includes an embedded chip.

10. A method of handling a biospecimen, the method comprising:
providing an apparatus for handling a biospecimen, the apparatus comprising a vial having a first open and a second closed end, an inner tube having a first open end and a second end formed with at least an aperture, the inner tube suitable for insertion into the first open end of the vial, and a lid portion suitable for securely covering over the first open end of the vial with or without the inner tube inserted therein;
introducing an appropriate amount of eluting solution into the vial;
inserting the inner tube into the first open end of the vial;
collecting a biospecimen;
placing the collected biospecimen in the inner tube beyond the trapping means in the tube;
closing the lid portion over the inner tube and the vial;
agitating the vial to transfer the biospecimen into the eluting solution.

11. The method of claim 10, wherein the vial is adaptable to receive a solution and the inner tube.

12. The method of claim 10, wherein the inner tube includes a trapping means for retaining a collected biospecimen.

13. The method of claim 12, wherein the trapping means is fixedly attached to the inlet of the open end of the inner tube.

14. The method of claim 10, wherein the second end of the inner tube is formed with multiple apertures.

15. The method of claim 10, wherein an identification label or tag is incorporated into the vial.

16. The method of claim 10, wherein the lid portion includes an embedded chip.
